(19) United States
(12) Patent Application Publication
(10) Pub. No.: US 2003/0006055 A1
(43) Pub. Date: Jan. 9, 2003

(54) Semiconductor package for fixed surface mounting

(75) Inventors: Lai Chien-Hung, Kaohsiung (TW); Lin Chien-Tsun, Kaohsiung (TW); Chang Chao-Chia, Kaohsiung (TW)

Correspondence Address: DOUGHERTY & TROXELL, Suite 1404, 5205 Leesburg Pike, Falls Church, VA, 22041, US

(73) Assignee: Walsin Advanced Electronics LTD

(21) Appl. No.: 09/898,053

(22) Filed: Jul. 5, 2001

(51) Int. Cl. H02G 3/08

(52) U.S. Cl. 174/52.1

(57) ABSTRACT

A semiconductor package for fixed surface mounting is disclosed, such as QFN, SON. The package includes a die, an encapsulant body sealing the die, a die pad supporting the die, and a plurality of leads electrically connecting with the die. The surface of die pad exposing outside the encapsulant body has grooves formed for improving the surface mounting to a printed circuit board.

### FIELD OF THE INVENTION

The present invention relates to a semiconductor package for fixed surface mounting, such as QFN (Quad Flat Non-leaded) and SON (Small Outline Non-leaded) package, particularly to a semiconductor package comprising a die pad with grooves.

### BACKGROUND OF THE INVENTION

It is familiar that semiconductor die is sealed by a package body of insulating thermosetting resin for protecting from the injury of hostile environment, and supported by a leadframe (leads) for electrically connecting the die of semiconductor package to a printed circuit board, such as Quad Flat Package (QFP) with outer leads around the package body or Small Outline Package (SOP) with outer leads at the two sides of package body.

With small size of semiconductor package, a semiconductor package with metal surface pads replacing of outer leads is brought up from U.S. Pat. No. 6,143,981 “Plastic Integrated Circuit Package And Method And Lead frame For Making The Package” in order to decrease the surface footprint. As shown in FIG. 5, a semiconductor package comprises a semiconductor die 56, an encapsulant body 40, a plurality of metal leads 53 and a metal die pad 24. The die pad 24 has an upside surface 25 which adheres the die 56. The metal bonding wires 58 electrically connect the bonding pads 56a of die 56 with the upside surfaces 31 of leads 53. And a plurality of bumps 60 are bonded on the underside surfaces 32 and outside surface 55 of lead 53 uncovered by encapsulant body 40 for surface mounting to a printed circuit board. However, in the foregoing semiconductor package, the die pad 24 of large area has no outer bonding function but being used to adhere the die 56 only, thus the semiconductor package is unable to get a good surface mounting to a printed circuit board.

### SUMMARY

The main object of the present invention is to provide a semiconductor package for fixed surface mounting, that the die pad holding the die has grooves formed on its exposed underside surface so that the semiconductor package can be fixedly surface-mounted to a printed circuit board.

A semiconductor package for fixed surface mounting in accordance with the present invention comprises:

a die pad having an upside surface and an underside surface;

a die having an upside surface , an underside surface and a plurality of bonding pads formed on the upside surface of the die, wherein the underside surface of die is adhered on the upside surface of die pad;

a plurality of leads having an upside surface and an underside surface;

a plurality of electrically connecting devices electrically connecting the bonding pads of the die with the upside surfaces of the corresponding leads;

an encapsulant body sealing the upside surface of the die, electrically connecting device and the upside surface of lead and exposing the partial underside surface of the plurality of leads and the underside surface of die pad; and

wherein the exposed underside surface of the die pad has grooves uncovered by the encapsulant body.

### DESCRIPTION OF THE DRAWINGS

FIG. 1 is a cross-sectional view of a semiconductor package in accordance with the first embodiment of the present invention.

FIG. 2 is a bottom view of leadframe for constructing the semiconductor package in accordance with the first embodiment of the present invention.

FIG. 3 is a drawing of various grooves type on the die pad of the semiconductor package in accordance with the first embodiment of the present invention.

FIG. 4 is a cross-sectional view of a semiconductor package mounted on a printed circuit board in accordance with the second embodiment of the present invention.

FIG. 5 is a cross-sectional view of semiconductor package disclosed in U.S. Pat. No. 6,143,981 “Plastic Integrated Circuit Package And Method And Lead frame For Making The Package”.

### DETAILED DESCRIPTION OF THE PRESENT INVENTION

Referring to the drawings attached, the present invention will be described by means of the embodiments below.

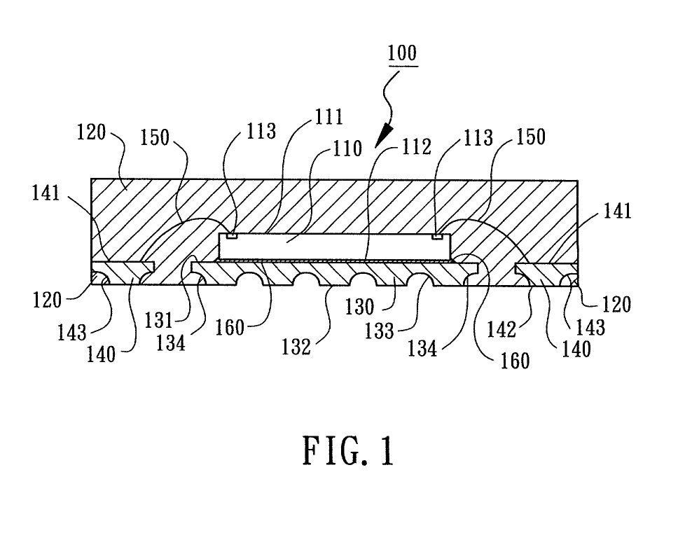

The first embodiment of the present invention is shown in FIG. 1, a semiconductor package 100 comprises a die 110, an encapsulant body 120, a die pad 130 and a plurality of leads 140.

The die 110 can be one kind of memory chip such as DRAM, SRAM, flash, etc, microprocessor, logic chip or radio frequency chip, made of silicon, gallium arsenside or other semiconductor material. The die 110 has an upside surface 111 and an underside surface 112. Commonly the die 110 has a plurality of bonding pads 113 and integrated circuit elements (not shown in the drawing) formed on the upside surface 111 of die 110. The underside surface 112 of die 110 is adhered on the die pad 130 by adhesive compound 160.

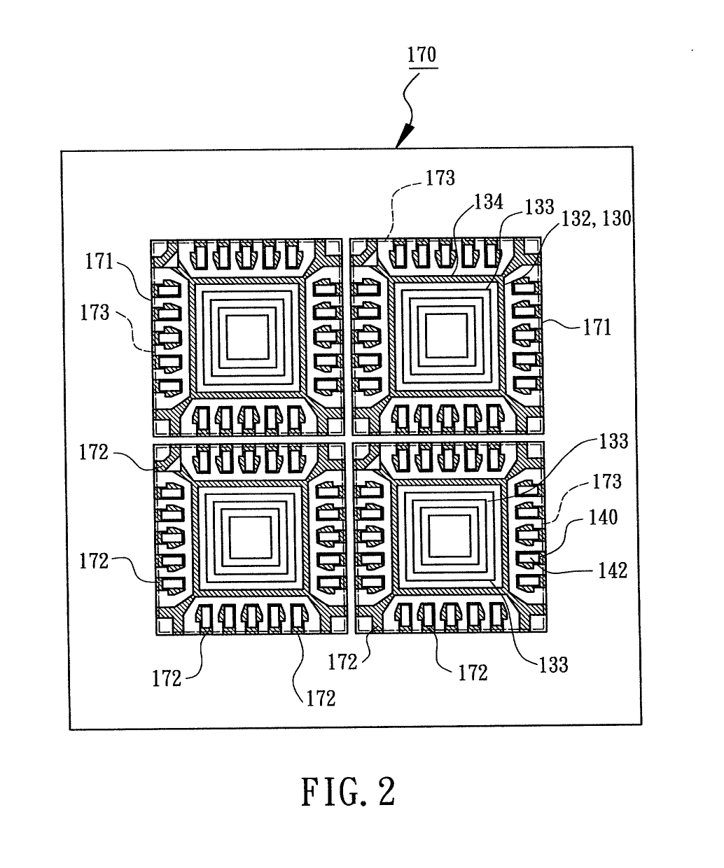

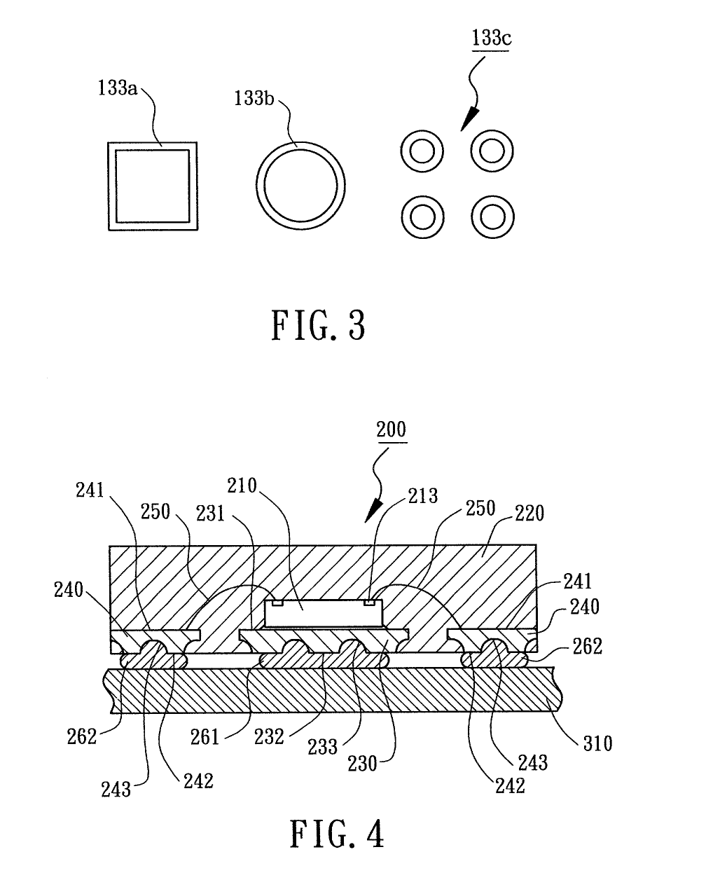

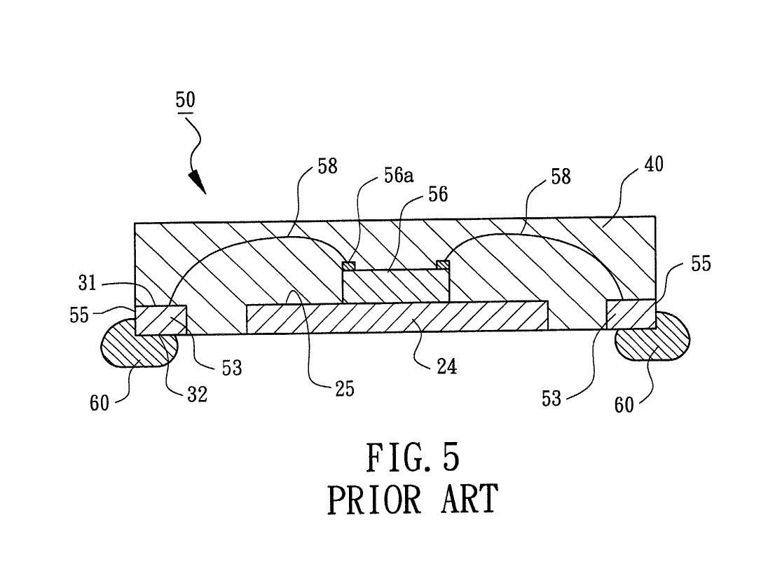

The die pad 130 has an upside surface 131 and an underside surface 132. The upside surface 131 of the die pad 130 is used for adhering the die 110, and has the slender grooves 133 and the gaps 134 around the underside surface 132. The gaps 134 are covered by encapsulant body 120 for increasing the stability and avoiding the die pad 130 falling off uneasily from the semiconductor package 100. The grooves 133 are formed on the exposed underside surface 132 of die pad 130 and uncovered by encapsulant body 120 so as to increase the adhesion of outer surface-mounting of the semiconductor package 100 with printed circuit board, such as mother board, memory module board or communication board, etc. In this embodiment, the grooves 133 are multi-ring type, such as multi-rectangle ring (as shown in FIG. 2), or as shown in FIG. 3, mono-rectangle ring type groove 133a, double-circle ring type groove 133b or multi-circle rings type grooves 133c replacing of groove 133. Besides, the die pad 130 is made of metal and formed from a same leadframe 170 with leads 140 (as shown in FIG. 2).

As shown in FIG. 2, each lead 140 has an upside surface 141 and an underside surface 142. The gaps 143 are formed around the underside surface 142 for fixedly being covered by encapsulant body 120, the underside surfaces 142 uncovered by encapsulant body 120 are outer electrical-connection of the semiconductor package 100. The upside surface 141 of lead 140 electrically connects to bonding pad 113 of die 110 by bonding wire 150 such as gold wire, copper wire or other metal wire. It is better that the exposed underside surfaces 142 of leads 140 and the exposed underside surface 132 of die pad 130 are formed on a same plane.

The encapsulant body 120 is used to protect the die 110 from invasion of moisture and dust, is a thermosetting insulating material which includes epoxy compound, adhesive and silicon filler to form a block type package body without outer leads extending by means of molding. The encapsulant body 120 mainly seals the upside surface 111 of die 110 and the upside surface 141 of lead 140, but exposes the partial underside surfaces 142 of leads 140 , the partial underside surface 132 and grooves 133 of die pad 130.

Therefore, for the foregoing semiconductor package 100 with QFN (Quad Flat Non-lead) type, the metal die pad 130 has not only the functions for fixing and holding the die 110, the grooves 133 on its exposed underside surface 132 but also ensures the semiconductor package 100 is mounted on printed circuit board more fixedly and better, meantime they increase the heat-dissipating area of die pad 130.

Moreover, it will not increase extra manufacturing cost for forming grooves 133. As shown in FIG. 2, die pad 130 and leads 140 come from a same leadframe which is made of a metal plate of thickness about 0.2 mm of copper, iron or alloy (alloy 42, including nickel 42% and iron 58%), or other alloy etc by means of well-used self-etching technique. The leadframe 170 has a plurality of frames 171 (in this embodiment, four frames are shown, in fact more than four), each frame 171 includes a semiconductor packaging area inside the adjacent cutting paths 173 for forming the semiconductor package 100 mentioned above. As shown in FIG. 2, the black-shadow portions mean the areas to be executed partial half-etching on the underside surface of the leadframe 170. In this embodiment a pre-determined thickness (about 0.1 mm) is etched to form the gap 134 of die pad 130, grooves 133 and the gaps 143 of lead 140 at the same time.

In the second embodiment of the present invention, as shown in FIG. 4, a semiconductor package 200 comprises a die 210, an encapsulant body 220, a die pad 230, a plurality of bonding wires 250 and a plurality of leads 240. The die 210, the encapsulant body 220 and the bonding wires 250 are as the same as the first embodiment, then it is unnecessary to describe again. The die pad 230 has an upside surface 231 for adhering a die 210 and an underside surface 232 forming the grooves uncovered by encapsulant body 220. The lead 240 has an upside surface 241 used to electrically connect with the bonding pad 213 of die 210 by bonding wires 250 and an underside surface 242 forming the hole uncovered 243 by encapsulant body 220. When a semiconductor package 200 is surface-mounted on a printed circuit board 310, the solder materials 262, 261 are respectively formed on the underside surfaces 242 of leads 240 and the exposed underside surface 232 of die pad 230 for surface mounting by means of methods of tin electroplating and lead-tin ball bonding. The bonding materials 262, 261 respectively fill the holes 243 of the leads and the grooves 233 of the die pad 230 so that the bonding strength of semiconductor package 200 and printed circuit board 310 is quite well.

The above description of embodiments of this invention is intended to be illustrative and not limiting. Other embodiments of this invention will be obvious to those skilled in the art in view of the above disclosure.

What is claimed is:

1. A semiconductor package comprising:
A metal die pad having an upside surface and an underside surface;
a die having an upside surface forming a plurality of bonding pads and an underside surface adhering to the upside surface of the die pad;
a plurality of leads having an upside surface and an underside surface;
a plurality of electrical connection devices electrically connecting the bonding pads of the die with the upside surfaces of the corresponding leads;
an encapsulant body sealing the upside surface of the die, electrical connection devices and the upside surfaces of the leads, and exposing the partial underside surfaces of the plurality of leads and the underside surface of the die pad; and
wherein the exposed underside surface of the die pad has at least one groove uncovered by the encapsulant body.

2. The semiconductor package of claim 1, wherein the exposed underside surfaces of the leads and the exposed underside surface of the die pad are formed on a same plane.

3. The semiconductor package of claim 1, wherein the groove is a rectangle type ring.

4. The semiconductor package of claim 1, wherein the groove is multi-ring type.

5. The semiconductor package of claim 1, wherein the plurality of electrical connection devices are the metal bonding wires.

6. The semiconductor package of claim 1, wherein the exposed underside surface of the lead has a hole.

7. The semiconductor package of claim 1, wherein the groove is filled with solder material.
